(19) United States
(12) Patent Application Publication
(10) Pub. No.: US 2012/0290783 A1
(43) Pub. Date: Nov. 15, 2012

(54) MEMORY DEVICE AND MEMORY SYSTEM INCLUDING THE SAME

(75) Inventors: Jung Soo CHUNG, Seoul (KR); Yong June KIM, Seoul (KR); Jun Jin KONG, Yongin-si (KR); Hongrak SON, Anyang-si (KR)

(73) Assignee: SAMSUNG ELECTRONICS CO., LTD., Suwon-si (KR)

(21) Appl. No.: 13/467,255

(22) Filed: May 9, 2012

(30) Foreign Application Priority Data
May 9, 2011 (KR) 10-2011-0043441

(51) Int. Cl. G06F 12/00

(52) U.S. Cl. 711/109; 711/154; 711/E12.001

(57) ABSTRACT

A memory device including a randomizer and a memory system including the memory device are provided. The memory device includes: a randomizer including a sequence generator which generates a first sequence from a seed and a converter which converts the first sequence into a second sequence in response to a conversion factor, the randomizer randomizing data to be programmed using the second sequence and outputting the randomized data; and a storage area which receives the randomized data from the randomizer and storing the randomized data.

### CROSS-REFERENCE TO RELATED APPLICATIONS

This application claims the benefit of Korean Patent Application No. 10-2011-0043441, filed on May 9, 2011, in the Korean Intellectual Property Office, the disclosure of which is incorporated herein in its entirety by reference.

### BACKGROUND

1. Field

Embodiments relate to a memory device and a memory system including the same. More particularly, embodiments relate to a memory device for increasing a two-dimensional randomness and a memory system including the memory device.

2. Description of the Related Art

There is increasing demand for high density and high performance. As a result of this demand, memory devices must include a greater number of memory cells per unit area. However, the reliability of the memory devices may deteriorate due to undesirable interaction between integrated memory cells.

### SUMMARY

Embodiments provide a memory device for increasing a randomness of a row direction and a column direction. A memory system includes the memory device.

According to an aspect of an exemplary embodiment, there is provided a memory device including: a randomizer including a sequence generator generating a first sequence from a seed and a converter converting the first sequence into a second sequence in response to a conversion factor, the randomizer randomizing data to be programmed using the second sequence and outputting the randomized data; and a storage area receiving the randomized data from the randomizer and storing the randomized data.

The converter may include a control unit generating the conversion factor; and a processing unit converting the first sequence into the second sequence in response to the conversion factor.

The processing unit may include a decimator extracting bits of the first sequence at an interval of the conversion factor and generating the second sequence.

The processing unit may include a cyclic shifter cyclically shifting the first sequence and converting the cyclically-shifted first sequence into the second sequence.

The processing unit may include a decimator extracting bits of the first sequence at an interval of the conversion factor and generating a temporary sequence, and a shifter shifting the temporary sequence and generating the second sequence.

The processing unit may include a cyclic shifter cyclically shifting the first sequence and generating a temporary sequence, and a decimator extracting bits of the temporary sequence at an interval of the conversion factor and generating the second sequence.

The converter may further include a buffer storing the first sequence and providing a stored first sequence to the processing unit, so that the processing unit converts the stored first sequence into the second sequence in response to a plurality of conversion factors.

The converter may include a plurality of processing units, and the control unit may provide the conversion factor to each of the plurality of processing units.

The control unit may generate the conversion factor by using a memory parameter, the conversion factor being coprime to a period of the first sequence and being smaller than the period of the first sequence and larger than or equal to “1”.

The control unit may generate the conversion factor having a size which is below a period of the first sequence, and may provide the conversion factor to the processing unit as a primitive value per each of memory parameters of data to be programmed or a relative value in which the primitive value per each of the memory parameters are arithmetically operated.

The randomizer may further include a seed table setting the seed and providing the seed to the sequence generator.

The randomizer may randomize the data to be programmed by performing an exclusive OR operation on the second sequence and the data to be programmed.

According to another aspect of the exemplary embodiments, there is provided a memory system including: a memory controller controlling a data programming and a data reading and outputting data to be programmed; a randomizer receiving the data to be programmed from the memory controller, generating a first sequence from a seed, converting the first sequence into a second sequence in response to a conversion factor, generating randomized data by performing an exclusive OR operation on the data to be programmed and the second sequence, and outputting the randomized data; and a memory device receiving the randomized data from the randomizer and storing the randomized data in a storage area of the memory device.

The randomizer may be located in the memory controller or the memory device.

The memory system may further include a de-randomizer receiving the stored randomized data in the storage area of the memory device, de-randomizing the randomized data, and outputting a derandomized data to the memory controller.

According to another aspect of the exemplary embodiments, there is provided a method of data programming in a memory device, the method including: generating a first sequence from a seed; converting the first sequence into a seed sequence in response to a conversion factor; randomizing data to be programmed using the second sequence; and storing the randomized data.

The converting the first sequence into the second sequence in response to the conversion factor may further include decimating the first sequence at an interval of the conversion factor; and generating the second sequence.

The converting the first sequence into the second sequence in response to the conversion factor may further include cyclically shifting the first sequence; and converting the cyclically-shifted first sequence into the second sequence.

### BRIEF DESCRIPTION OF THE DRAWINGS

Exemplary embodiments will be more clearly understood from the following detailed description taken in conjunction with the accompanying drawings in which:

FIG. 1A is a block diagram of a memory device according to an embodiment ;

FIG. 1B is a flowchart illustrating a data programming method of the memory device, according to an embodiment;

FIGS. 2A through 2C are diagrams illustrating a structure and an operation of a memory cell array of FIG. 1A;

FIGS. 3A through 3C are diagrams illustrating a sequence generator included in a randomizer of FIG. 1A;

FIG. 4 is a block diagram illustrating a converter of a randomizer of FIG. 1A;

FIGS. 5A and 5B are diagrams illustrating the converter according to an embodiment;

FIGS. 6A through 6D are diagrams illustrating the converter according to another embodiment;

FIGS. 7A through 7C are diagrams illustrating the converter according to another embodiment;

FIGS. 8A through 8C are diagrams illustrating the converter according to another embodiment;

FIG. 9 is a diagram illustrating the converter according to another embodiment ;

FIGS. 10A and 10B are flowcharts illustrating embodiments of an operation of the data programming method in the memory device;

FIG. 11 is a block diagram of a memory system according to an embodiment ;

FIG. 12 is a block diagram of a memory system according to another embodiment;

FIG. 13 is a block diagram illustrating a memory system including a plurality of memory devices, according to another embodiment;

FIG. 14 is a block diagram illustrating a computing system including the memory system of FIG. 11, according to an embodiment;

FIG. 15 is a diagram illustrating a memory card according to an embodiment ;

FIG. 16 is a diagram illustrating a solid state drive according to an embodiment; and

FIG. 17 is a diagram illustrating a server system including a solid state drive and a network system including the server system.

### DETAILED DESCRIPTION OF THE EMBODIMENTS

The attached drawings for illustrating exemplary embodiments of the inventive concept are referred to gain a sufficient understanding of the inventive concept and the merits thereof accomplished by the implementation of the inventive concept.

Hereinafter, embodiments will be described in detail by explaining exemplary embodiments thereof with reference to the attached drawings. Like reference numerals in the drawings denote like elements.

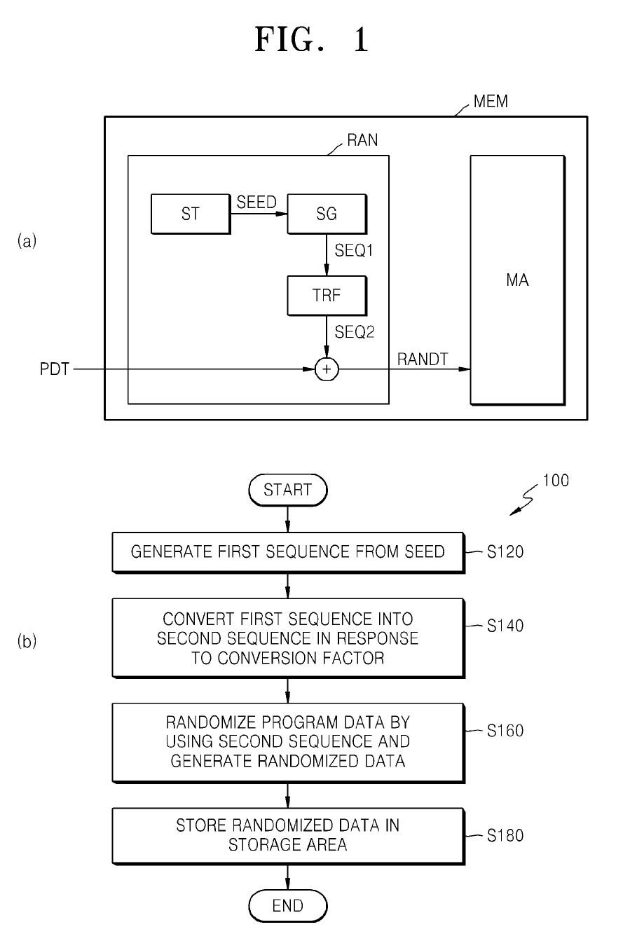

FIG. 1A is a block diagram of a memory device MEM according to an embodiment FIG. 1B is a flowchart illustrating a data programming method 100 of the memory device MEM, according to an embodiment.

The memory device MEM of FIG. 1A may perform a data programming operation by using the method of FIG. 1B. A randomizer RAN of the memory device MEM randomizes data PDT to be programmed (hereinafter referred to as “program data”), and then outputs randomized data RANDT (hereinafter referred to as “random data”). A randomization operation means an operation for randomly resetting bit values of the program data PDT. In the randomizer RAN, a sequence generator SG generates a first sequence SEQ1 from a seed SEED generated in a seed table ST (operation S120). A converter TRF converts the first sequence SEQ1 into a second sequence SEQ2 in response to a conversion factor (operation S140). In addition, the randomizer RAN randomizes the program data PDT with the second sequence SEQ2, and generates and outputs the random data RANDT (operation S160). The random data RANDT is provided to a storage area of the memory device MEM, i.e., a memory cell array MA, which stores the random data RANDT (operation S180).

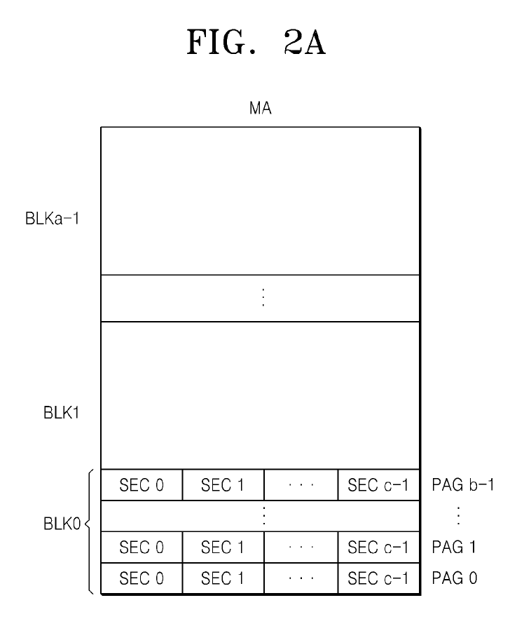

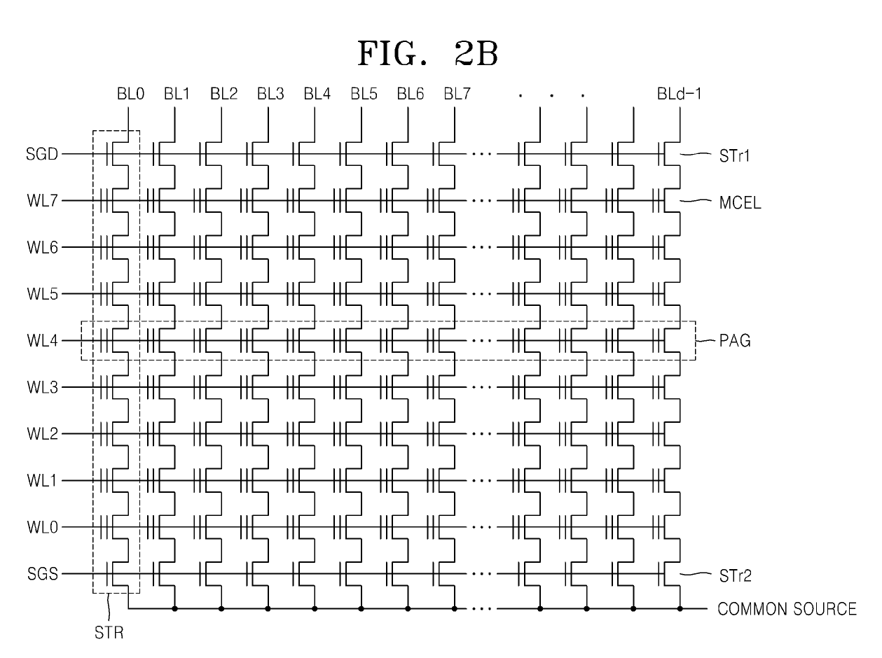

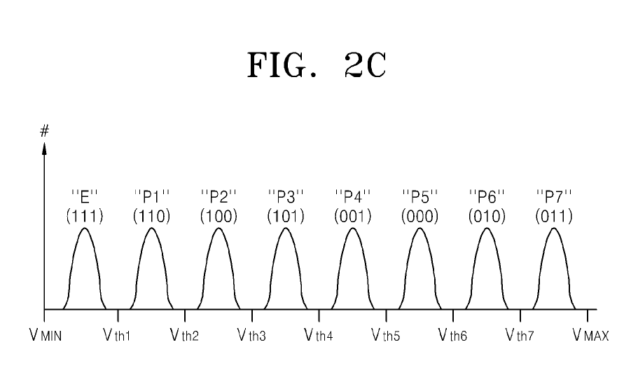

The memory cell array MA, which is the storage area of the memory device MEM, may include a structure illustrated in FIG. 2A. FIG. 2A is a diagram illustrating a structure and an operation of the memory cell array MA of FIG. 1A. The memory cell array MA may include blocks BLK0 through BLKa-1 (a is an integer which is 2 or more), each of the blocks BLK0 through BLKa-1 may include pages PAG0 through PAGb-1 (b is an integer which is 2 or more), and each of the pages PAG0 through PAGb-1 may include sectors SEC0 through SECc-1 (c is an integer which is 2 or more). In FIG. 2A, the pages PAG0 through PAGb-1 and the sectors SEC0 through SECc-1 are illustrated only in the block BLK0. However, other blocks BLK1 through BLKa-1 may have the same structure as that of the block BLK0.

In the case where the memory cell array MA is a NAND flash memory cell array, each of the blocks BLK0 through BLKa-1 of FIG. 2A may include a structure shown in FIG. 2B of the memory cell array MA. FIG. 2B is a diagram illustrating the memory cell array MA of FIG. 1A. Referring to FIG. 2B, each of the blocks BLK0 through BLKa-1 may include d strings STR [symbol] (d is an integer which is 2 or more) in which a plurality of memory cells MCEL are connected in series. Memory cells MCEL are connected in series in a direction in which bit lines BL0 through BLd-1 are arranged. In particular, FIG. 2B illustrates an example in which each of the d strings STR includes 8 memory cells MCEL. In addition, each of the d strings STR may include a drain selection transistor Str1 and a source selection transistor Str2, which are connected to both ends of the serially connected memory cells MCEL.

A NAND flash memory device having the NAND flash memory cell array structure of FIG. 2B performs an erase operation and a programming operation. The erase operation removes electrons stored in a floating gate of each memory cell in a block unit. The programming operation which stores electrons in the floating gate of each of the memory cells in a page unit PAG of each word line WL0 through WL7. FIG. 2B illustrates an example in which one block includes 8 pages PAG corresponding to 8 word lines WL0 through WL7. However, each of the blocks BLK0 through BLKa-1 of the memory cell array MA may include a different number of memory cells from that of the memory cells MCEL illustrated in FIG. 2B, and a different number of pages from that of the pages PAG illustrated in FIG. 2B.

FIG. 1 illustrates the case where the memory device MEM includes only one memory cell array MA. However, embodiments are not limited. The memory device MEM may include a plurality of memory cell arrays which have the same structure as that of the memory cell array MA and perform the same operation as that of the memory cell array MA. Only the case where the memory device MEM has only one memory cell array MA is described.

The memory cells MCEL of a memory device having a memory cell array with the structure of FIG. 2B may store one bit or a plurality of bits. For example, as shown in FIG. 2C, if data is 3 bits, each of the memory cells MCEL may have a threshold voltage Vth included in one of the cell distributions depending on stored data values. For 3 bits, the stored data values may be “111”, “110”, “100”, “101”, “001”, “000”, “010”, and “011”. FIG. 2C indicates cell distributions of a 3-bit multi-level cell (MLC) flash memory device. In other words, FIG. 2C illustrates 8 states, i.e., “E” and “P1” through “P7”, for threshold voltages Vth of memory cells according to 3-bit data values. However, data values according to the 8 states may be set in different variations.

Recently, due to increased demand for high density and high performance in memory devices, a distance between the memory cells MCEL of FIG. 2B is being reduced. In addition, a number of states for threshold voltages of the memory cells MCEL is increased. Thus, a coupling phenomenon may occur between adjacent memory cells MCEL in the same string or between adjacent memory cells MCEL in the same page. In addition, as a data programming is sequentially performed on each of the pages, a back pattern dependency (BPD) phenomenon may occur. A BPD phenomenon is when a threshold voltage of a memory cell of a page previously programmed varies by a program voltage applied to a memory cell of a page subsequently programmed.

Due to the coupling phenomenon and the BPD phenomenon, threshold voltages of memory cells may change. For example, because a threshold voltage distribution graph of a corresponding memory cell is being biased in one side compared to a real threshold voltage distribution, a threshold voltage distribution of the corresponding memory cell may be formed broader than the real threshold voltage distribution. In this case, an error of a read operation may occur. In other words, the memory device may output false data. The memory device MEM according to an embodiment may randomize data and increase a randomness of a row direction (a page direction) and a column direction (a string direction) to average the coupling phenomenon and the BPD phenomenon.

Referring back to FIG. 1, the randomizer RAN converts the first sequence SEQ1 generated by the sequence generator SG, according to the conversion factor Tf, into the second sequence SEQ2, and randomizes the program data PDT with the second sequence SEQ2, to increase the randomness of the row direction and the column direction.

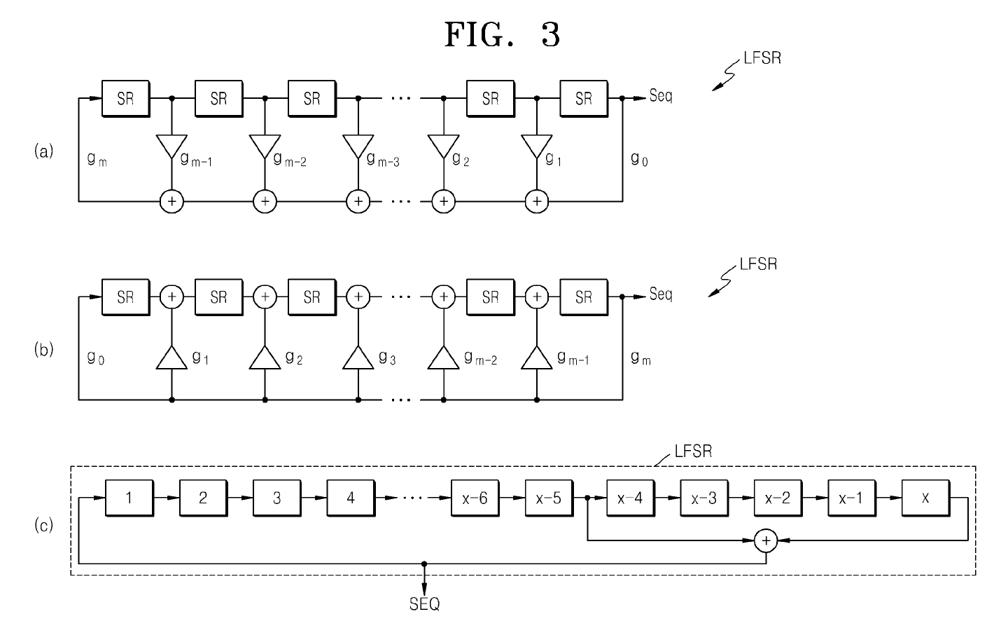

As illustrated in FIG. 3, the sequence generator SG of the randomizer RAN may include a linear feedback shift register (LFSR) including m shift registers SR (here, m is an integer which is 2 or more). FIG. 3A illustrates an LFSR which is implemented by the Fibonacci method. FIG. 3B illustrates an LFSR which is implemented by the Galois method. The sequence generator SG may include an LFSR which is implemented by the Galois method. However, only the case where the sequence generator SG includes an LFSR implemented by the Fibonacci method is explained. The sequence generator SG including the LFSR of FIG. 3A may be embodied similar to FIG. 3C.

As illustrated in FIG. 3C, an operation of an LFSR may be represented as g(z) in the following Equation 1.

g(z)=gₘz^{m}+gₘ₋₁z^{m-1}+ . . . +g₁z¹+g₀ Equation 1

Generally, it is advisable to use a primitive polynomial in g(z) of Equation 1. If the primitive polynomial is used, a period L(SEQ) of an output SEQ of an LFSR including m shift registers SR may be represented as L(SEQ) in the following Equation 2.

L(SEQ)=2^{m}−1 Equation 2

The LFSR of FIG. 3C may include x shift registers 1 through x (x is an integer which is 2 or more). A sequence SEQ may be a result of an exclusive OR operation performed on an output of a shift register x located at a last stage of the x serially connected shift registers 1 through x and an output of an arbitrary shift register, i.e., a shift register x-5 of the x serially connected shift registers 1 through x. The sequence SEQ is fed back to a shift register 1 located at a first stage of the x serially connected shift registers 1 through x. The arbitrary shift register, of which an output performs an exclusive OR operation with the output of the shift register x located at the last stage, may be determined depending on an extent of randomness required by the randomizer RAN.

Referring to FIG. 1A and FIG. 3C, the sequence generator SG may receive the seed SEED, which is an initial bit value, from a seed table STThen, the sequence generator SG may generate the first sequence SEQ1. In other words, each of the shift registers SR of the sequence generator SG may be initialized with the seed SEED provided from the seed table ST. Then, the first sequence SEQ1 is generated by performing a shift operation. The seed table ST may set the seed SEED by using various methods and provide the seed SEED to the sequence generator SG. According to an embodiment, the seed table ST may set the seed SEED with a pre-stored value with regard to one or a combination of two or more memory parameters, i.e., the pages PAG0 thorough PAGb-1, the blocks BLK0 through BLKa-1, and the sectors SEC0 thorough SECc-1 of FIG. 2A. If the seed SEED is set with the pre-stored value, when programming the program data PDT in the page unit, the shift register SR may be initialized only by the seed SEED set with the pre-stored value even though pages of the program data PDT are changed. Then, the shift register SR may generate the first sequence SEQ1. In other words, the shift register SR may generate the first sequence SEQ1 when the seed SEED is fixed. According to another embodiment, the seed table ST may initialize the LFSR by setting the seed SEED corresponding to the pages PAG0 through PAGb-1, the blocks BLK0 through BLKa-1, or the sectors SEC0 through SECc-1 whenever pages, blocks, or sectors of the program data PDT are changed. The first sequence SEQ1 may be generated from the LFSR. In addition, in this case, the seed SEED may be set with regard to one memory parameter or a combination of two or more memory parameters. As illustrated in FIG. 1, the seed table ST may be included in the randomizer RAN. However, the embodiments are not limited. The seed table ST may be separately included from the randomizer RAN.

As illustrated in FIG. 3C, if the sequence generator SG of FIG. 1A includes x shift registers SR and the primitive polynomial is used, the first sequence SEQ1, i.e., the output of the sequence generator SG may be represented as L(SEQ1) in the following Equation 3.

L(SEQ1)=2^{x}−1 Equation 3

The first sequence SEQ1 having a period L(SEQ1) of Equation 3 may be a pseudo-noise (PN) sequence. In particular, if the first sequence SEQ1 is a maximal length sequence, i.e., an M-sequence, the first sequence SEQ1 may have a period 2^{m}−1 (m is the number of shift registers SR). Therefore, the first sequence SEQ1 may have ideal autocorrelation characteristics. Accordingly, if the first sequence SEQ1 is short, i.e., m is small, the same pattern may be generated in a page direction. In addition, in view of run characteristics, i.e., a numerical progression in which “0” or “1” continues, if a period of the first sequence SEQ1 is long, i.e., m is large, “0” may be continuously generated or “1” may be continuously generated. Therefore, the first sequence SEQ1 may have a vulnerable randomness not only in the row direction (the page direction) but also in the column direction (the string direction), depending on a degree x. Thus, a malfunction of a system may be caused due to the coupling phenomenon and the BPD phenomenon between adjacent memory cells.

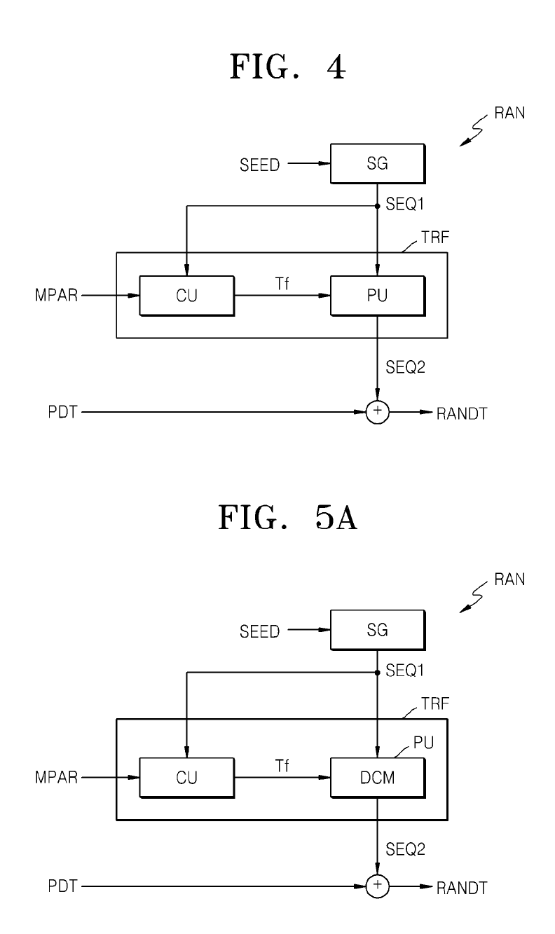

Referring back to FIGS. 1A and 4, the converter TRF of the randomizer RAN may convert the first sequence SEQ1 generated by the sequence generator SG into the second sequence SEQ2. The second sequence SEQ2 is a different sequence from the first sequence SEQ1. The converter TRF is illustrated in FIG. 4. FIG. 4 is a block diagram illustrating a converter of a randomizer of FIG. 1A. The converter TRF may include a control unit CU for providing the conversion factor Tf to a processing unit PU. The processing unit PU performs a conversion of the first sequence SEQ1 based on the conversion factor Tf, and generates the second sequence SEQ2. The control unit CU may generate the conversion factor Tf based on the memory parameter MPAR, provide the conversion factor Tf to the processing unit PU, and control a conversion method for the first sequence SEQ1 in the processing unit PU. The converter TRF may store the conversion factor Tf generated by the control unit CU into a conversion factor table TFT (not shown). By storing the conversion factor Tf, the conversion factor Tf may be provided in various methods during a conversion of the first sequence SEQ1. For example, in the case of converting a plurality of first sequences SEQ1, the same conversion factors Tf may be provided or different conversion factors Tf may be provided. The conversion factor table TFT may be included in the control unit CU, or may be included separately from the control unit CU.

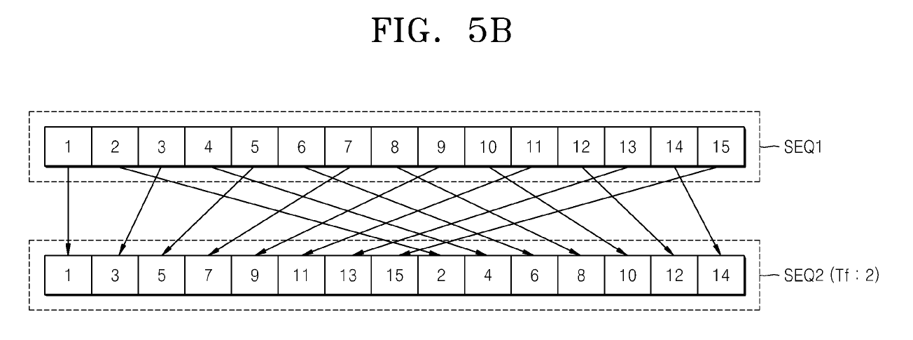

FIGS. 5A and 5B illustrate the converter TRF according to an embodiment. Referring to FIG. 5A, the processing unit PU of the converter TRF may include a decimator DCM. The decimator DCM decimates the first sequence SEQ1 in response to the conversion factor Tf, and then generates the second sequence SEQ2. The decimation extracts arbitrary bits of the first sequence SEQ1 and then generates the second sequence SEQ2. For example, arbitrary bits of the first sequence SEQ1 may be selected and reconstituted at an interval of the conversion factor Tf. Thus, the second sequence SEQ2, which has a bit sequence different from that of the first sequence SEQ1, may be generated.

The control unit CU may generate the conversion factor Tf based on the memory parameters. The control unit may arbitrary provide the conversion factor Tf to the decimator DCM ins the processing unit PU. In addition, the control unit CU may receive information about a period of the first sequence SEQ1 from the sequence generator SG, generate the conversion factor Tf according to a predetermined rule, and then provide the conversion factor Tf to the decimator DCM. For example, the control unit CU, by using one or a combination of two or more of the memory parameters, i.e., a page number, a word line number, a block number, a chip number, and an erase count, may provide the processing unit PU with a parameter (i.e., the conversion factor Tf), which has a size coprime to a period of the first sequence SEQ1 (here, it is assumed that the first sequence SEQ1 satisfies Equation 3) and which has a size smaller than the period and is larger than or equal to “1”.

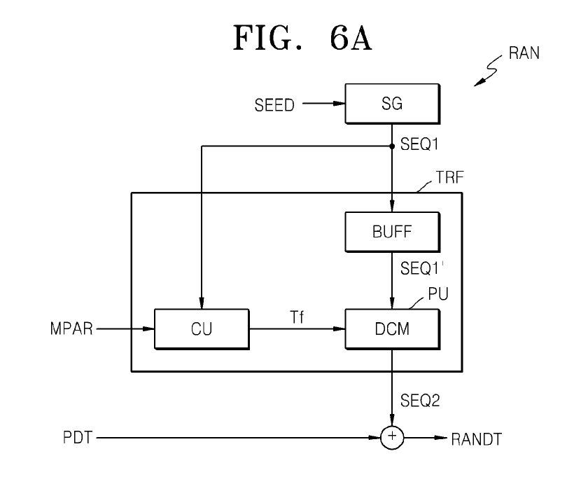

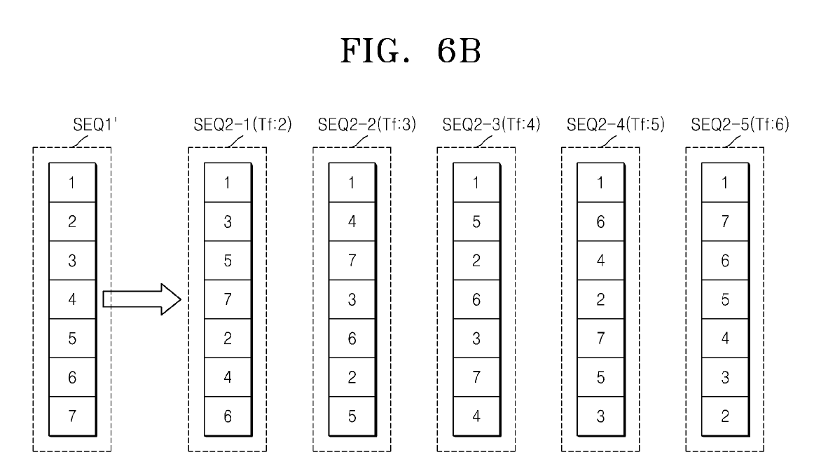

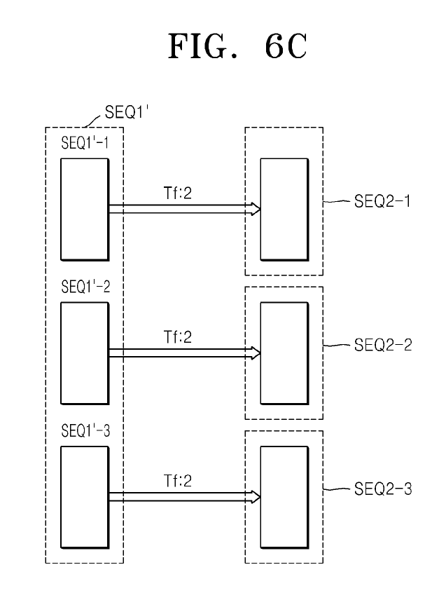

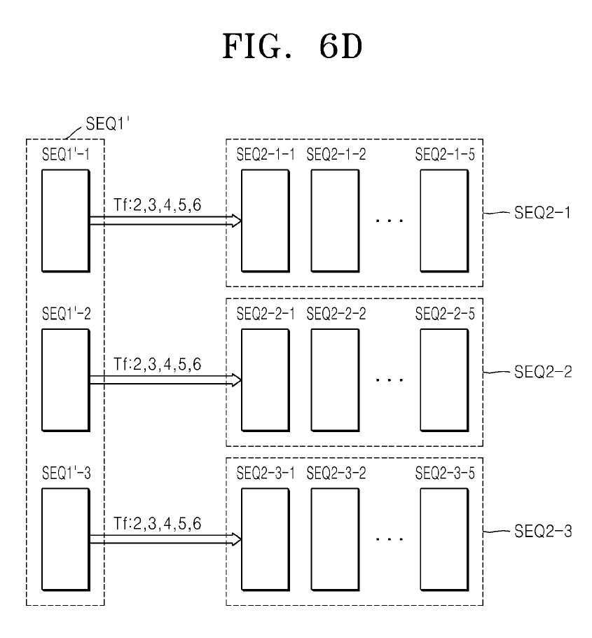

In the case of FIG. 5B, where the period of the first sequence SEQ1 is 15 and the conversion factor Tf is 2, the first sequence SEQ1 is converted into the second sequence SEQ2 by using the decimation. In FIG. 5B, “1” through “15” of the first sequence SEQ1 indicates the order of a numerical progression generated by the sequence generator SG (this also applies to FIGS. 6B, 7B, and 8B).

Referring to FIG. 5B, the decimator DCM may extract bits of the first sequence SEQ1 at an interval of the conversion factor Tf of 2 and generate the second sequence SEQ2. The conversion factor Tf of 2 is coprime to the period 15 of the first sequence SEQ1, is larger than 1, and is smaller than the period. Numbers which are coprime to the period 15 are larger than 1 and are smaller than the period of the first sequence SEQ1, i.e., 4, 7, 8, 11, 13, and 14, and may be provided to the decimator DCM as another conversion factor Tf. The decimator DCM may decimate and convert the first sequence SEQ1 generated from the sequence generator SG according to the conversion factor Tf. FIG. 5B illustrates the case where the decimator DCM continuously decimates the first sequence SEQ1 according to the conversion factor Tf of 2. Thus, the second sequence SEQ2 is generated with a length equal to that of a numerical progression of the first sequence SEQ1. However, embodiments are not limited. The second sequence SEQ2 may be sequentially decimated by conversion factors which are different from the conversion factor Tf of 2 and may be generated with a length equal to the numerical progression of the first sequence SEQ1.

FIGS. 6A through 6D illustrate the converter TRF according to another embodiment. Referring to FIG. 6A, a processing unit PU of the converter TRF may include a decimator DCM and a buffer BUFF. The decimator DCM may be the same as that of FIG. 5A. The buffer BUFF receives the first sequence SEQ1 from the sequence generator SG, stores the first sequence SEQ1, and provides a stored first sequence SEQ1′ to the decimator DCM. In addition, the first sequence SEQ1′ stored in the buffer BUFF may be one or more first sequences SEQ1. In the case where a plurality of first sequences SEQ1 are stored in the buffer BUFF and provided to the decimator DCM, each of the plurality of first sequences SEQ1 may be decimated by the same conversion factor Tf, or a different conversion factor Tf, or a plurality of conversion factors Tf respectively. This may be embodied through the conversion factor table TFT. The buffer BUFF allows the decimator DCM to perform various decimation operations.

As illustrated in FIG. 6B, the decimator DCM of FIG. 6A may simultaneously decimate the stored first sequences SEQ1′ based on each of a plurality of conversion factors Tf. FIG. 6B illustrates a decimation operation for the first sequence SEQ1′ of which a period of 7 is stored in the buffer BUFF. As illustrated above, the control unit CU may provide the decimator DCM with arbitrary conversion factors Tf (2, 3, 4, 5, and 6) which are coprime to the period 7 of the stored first sequence SEQ1′, larger than 1, and smaller than the period. The decimator DCM may simultaneously decimate the stored first sequences SEQ1′ based on the conversion factors Tf, respectively, and generate second sequences SEQ2-1 through SEQ2-5. The second sequences SEQ2-1 through SEQ2-5 may be continuously decimated with a corresponding conversion factor Tf and be generated with a length equal to the numerical progression of the first sequence SEQ1′ stored in the buffer BUFF. However, embodiments are not limited. The second sequences SEQ2-1 through SEQ2-5 may be sequentially decimated by a plurality of conversion factors Tf and be generated with a length equal to the numerical progression of the first sequence SEQ1′ stored in the buffer BUFF.

As illustrated in FIG. 6C, the second sequences SEQ2-1, SEQ2-2, and SEQ2-3 may be generated by simultaneously decimating the plurality of stored first sequences SEQ1′-1, SEQ1′-2, and SEQ1′-3, according to the conversion factor Tf of 2. Also, referring to FIG. 6D, the plurality of stored first sequences SEQ1′-1, SEQ1′-2, and SEQ1′-3 of which a periods are 7 may be simultaneously decimated based on the conversion factors Tf (2, 3, 4, 5, and 6) (refer to FIG. 6B) which are coprime to the period 7, respectively. Therefore, various second sequences SEQ2-1-1 through SEQ2-1-5, SEQ2-2-1 through SEQ2-2-5, and SEQ2-3-1 through SEQ2-3-5 having different values may be generated. As stated above, because the amount of decimation execution of the decimator DCM may be increased due to the buffer BUFF, the memory device MEM may operate at a high speed and the first sequence SEQ1 may be effectively converted.

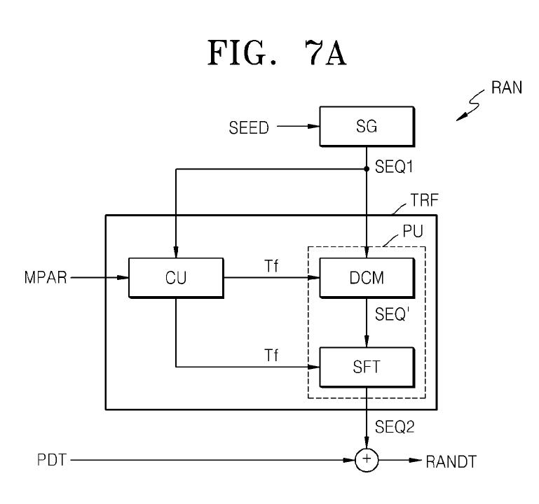

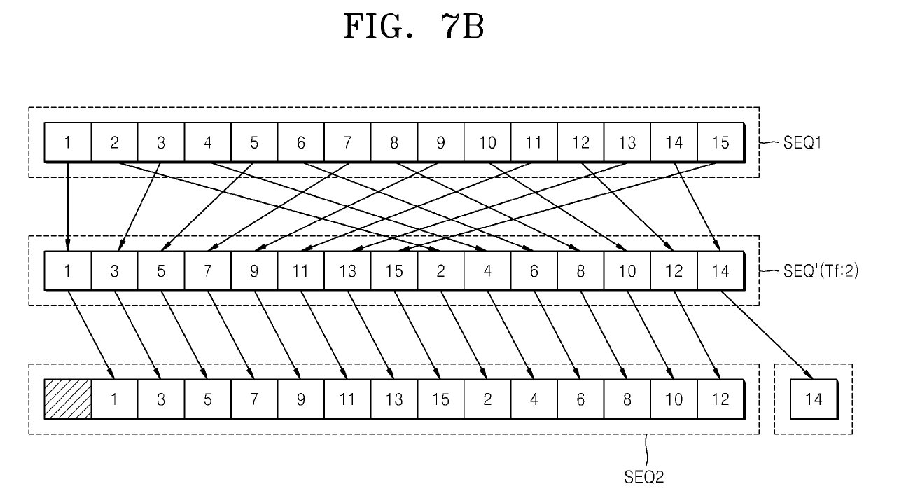

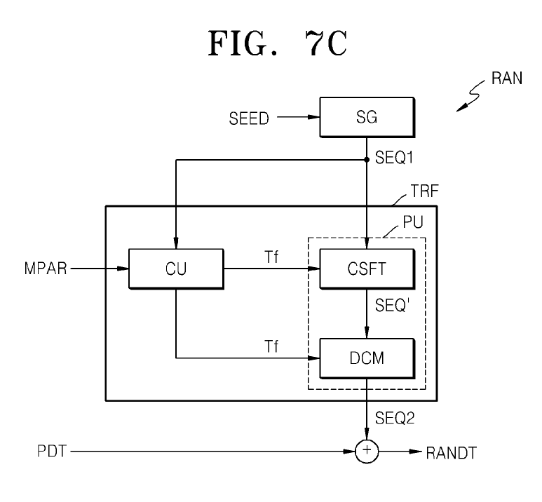

FIG. 7A through 7C illustrate the converter TRF according to another embodiment. Referring to FIG. 7A, a processing unit PU of the converter TRF may include a decimator DCM and a shifter SFT. The shifter SFT may shift a temporary sequence SEQ′ generated by decimating a first sequence SEQ1. Thus, the shifter SFT may generate a second sequence SEQ2. If a plurality of temporary sequences SEQ′ decimated by the decimator DCM have equal values to each other as a first stage bit value, various second sequences, of which first stage bit values are different, may be generated as the shifter SFT shifts the temporary sequences SEQ′. A shift method of the shifter SFT may be a linear shift, an arithmetic shift, a decimal shift, a cyclic shift, etc. A control unit CU may provide a conversion factor Tf to the shifter SFT. In this case, the conversion factor Tf may be set depending on a shift method performed by the shifter SFT. For example, if the shifter SFT performs the linear shift, the conversion factor Tf may be set when a shift direction of the shifter SFT is set in a left side or right side, or may be set when the number of bits moving in the shift direction is arbitrarily set.

FIG. 7B illustrates a process of generating the second sequence SEQ2 by shifting the temporary sequence SEQ′. Referring to FIG. 7B, the temporary sequence SEQ′ may be generated by decimating the first sequence SEQ1 of a period 15, based on a conversion factor Tf of 2. In FIG. 7B, as in FIG. 5B, the decimator DCM continuously decimates the first sequence SEQ1 with the conversion factor Tf of 2. Thus, the temporary sequence SEQ′ is generated with a length equal to that of a numerical progression of the first sequence SEQ1. However, as stated above, embodiments are not limited.

Referring to FIG. 7B again, the second sequence SEQ2 may be generated by linear-shifting the temporary sequence SEQ′ to the right side by one bit. The linear shift is a shift method of moving data stored in the shifter SFT to a left side or a right side in turn by one bit. In the linear shift, a bit pushed out of the shifter SFT is lost and a blank space of the shifter SFT is filled with logic 0. Accordingly, a bit of a first stage “1” of the temporary sequence SEQ′ is filled with logic 0, and a bit of a last stage “14” of the temporary sequence SEQ′ is lost. The shifter SFT illustrated in FIG. 7A may include a plurality of shifters, and a randomness may be further increased through the plurality of shifters. In addition, the processing unit PU of the converter TRF illustrated in FIGS. 5A and 6A may further include the shifter SFT.

Referring to FIG. 7C, the processing unit PU of the converter TRF may include a cyclic shifter CSFT and a decimator DCM. The cyclic shifter CSFT may cyclically shift the first sequence SEQ1. Thus, the cyclic shifter CSFT may convert a cyclically-shifted first sequence into the temporary sequence SEQ′. The decimator DCM may decimate the temporary sequence SEQ′ and generate the second sequence SEQ2. Bit values of the first sequence SEQ1 may not be lost. Bit values of the second sequence SEQ2 may be diversified through various cyclic shift and decimation methods. The processing unit PU may include a plurality of cyclic shifters CSFT.

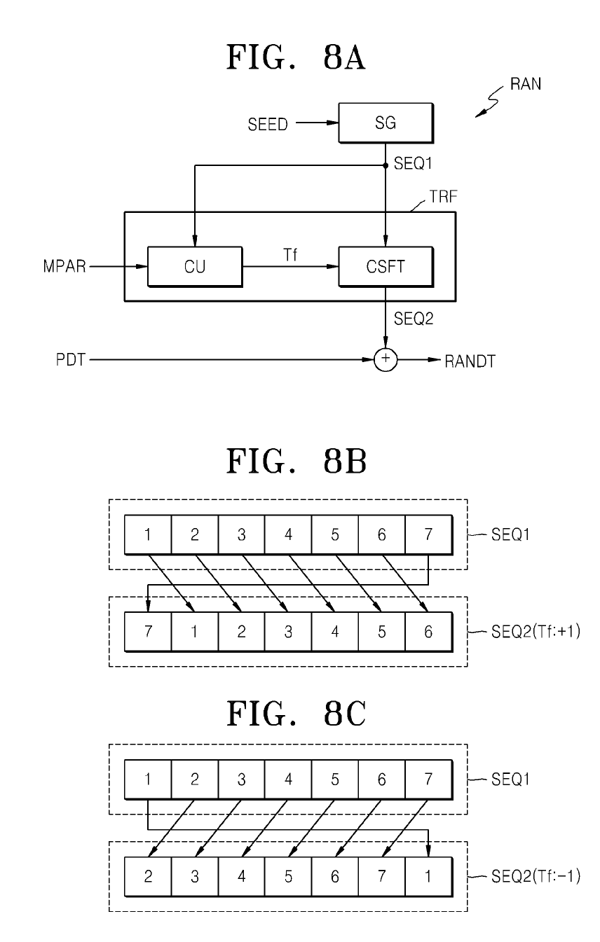

FIGS. 8A and 8B illustrate a fourth embodiment of the converter TRF. Referring to FIG. 8A, a processing unit PU of the converter TRF may include a cyclic shifter CSFT. The cyclic shifter CSFT may cyclically shift a first sequence SEQ1. The cyclic shifter CSFT shifts the first sequence SEQ1 to a left side or a right side based on a conversion factor Tf provided from a control unit CU. A bit value of a last stage of the first sequence SEQ1 is input to a first stage of the first sequence SEQ1 or a bit value of the first stage of the first sequence SEQ1 is input to the last stage of the first sequence SEQ1. Thus, a loss of bits does not occur. The control unit CU may receive information about a period (refer to Equation 3) of the first sequence SEQ1 from a sequence generator SG. The control unit CU provides the processing unit PU with a conversion factor Tf having a value (right side: 0≦Tf<2^{x}−1 or left side: −(2^{x}−1)<Tf≦0) which is equal to or smaller than the period of the first sequence SEQ1. Thus, the control unit CU controls the cyclic shifter CSFT. In other words, the cyclic shifter CSFT may cyclically shift to a left side (a negative sign: −) or a right side (a positive sign: +) based on the conversion factor Tf provided from the control unit CU.

FIG. 8B illustrates a process in which a bit of a last stage “7” of the first sequence SEQ1 having a period 7 is input to a first stage “1” of the first sequence SEQ1 and bits of all stages of the first sequence SEQ1 are moved to the right side by one bit. Thus, a second sequence SEQ2 is generated by a cyclic shift (Tf is +1). FIG. 8C illustrates a process in which a bit of the first stage “1” of the first sequence SEQ1 having a period 7 is input to the last stage “7” of the first sequence SEQ1 and bits of all stages of the first sequence SEQ1 are moved to the left side by one bit. Thus, a second sequence SEQ2 is generated by a cyclic shift (Tf is −1). The cyclic shifter CSFT may cyclically shift the first sequence SEQ1 based on various conversion factors Tf and thus may generate the second sequence SEQ2.

The control unit CU may provide the processing unit PU with the conversion factors Tf having a primitive value (for example, when x is 4, the period 2^{x}−1 is 15 and thus Tf is 0,±1˜±14 per each of the memory parameters corresponding to program data PDT). In addition, the control unit CU may arithmetically operate a primitive value per each of the memory parameters corresponding to the program data PDT and provide a relative value (for example, when x is 4, Tf is [±]1, 3, 10, 6, 9, 7, . . . , or 15). For example, when x is 4, in the case where the control unit CU provides the conversion factors Tf having the primitive value, each of the conversion factors Tf may be stored with 4 bits (for example, “1111”). However, in the case where the primitive value is provided by arithmetically operating with a relative value such as a multiple of three, each of the conversion factors Tf may be stored with 2 bits (for example, a relative value 3 may be represented as “11” because differences between the conversion factors Tf are 3 and the same as each other). Thus, a required storage space may be reduced.

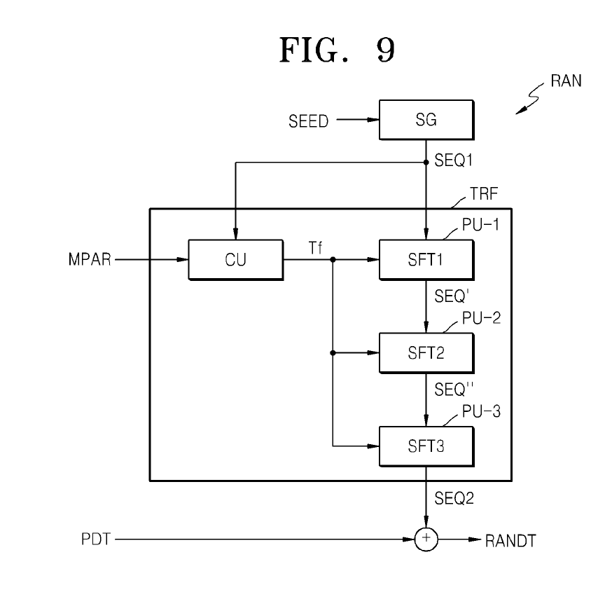

FIG. 9 illustrates the converter TRF according to another embodiment. The converter TRF may include a plurality of processing units PU-1, PU-2, and PU-3, which may include corresponding shifters SFT1, SFT2, and SFT3. Each of the shifters SFT1, SFT2, and SFT3 may receive a conversion factor Tf from a control unit CU and perform a shift operation. The shifter SFT1 and the shifter SFT2 may perform shift operations and generate a first temporary sequence SEQ′ and a second temporary sequence SEQ″, respectively, and the shifter SFT3 may shift the second temporary sequence SEQ″ and generate a second sequence SEQ2. A shift method performed in FIG. 9 may be a linear shift, an arithmetic shift, a decimal shift, etc.

Referring back to FIG. 1A, the randomizer RAN may randomize the program data PDT by using the second sequence SEQ2 and output random data RANDT to a storage area of the memory device MEM, i.e., the memory cell array MA. The random data RANDT may be generated by performing an exclusive OR operation on the second sequence SEQ2 and the program data PDT. In addition, FIG. 1A illustrates an additive type randomizer in which the program data PDT and the second sequence SEQ2, which is an output of the converter TRF, undergo an exclusive OR operation. However, embodiments are not limited. The randomizer RAN may be a multiplicative type randomizer. In the multiplicative type randomizer, the program data PDT and the second sequence SEQ2, which are an output of the converter TRF, undergo an exclusive OR operation. Also, the second sequence SEQ2 is input to a shift register located at a first stage of the sequence generator SG.

In the case where the randomizer RAN of the memory device MEM according to an embodiment generates the second sequence SEQ2, different from the first sequence SEQ1, through various conversion methods and then generates the random data RANDT through the second sequence SEQ2, an issue in which the same pattern or same bit value (“0” or “1”) is repeated in a row direction and a column direction may be alleviated. Accordingly, the memory device MEM according to an embodiment may average a coupling phenomenon between adjacent memory cells. Thus, a malfunction of the memory device MEM may be prevented and a reliability of the memory device MEM may be improved.

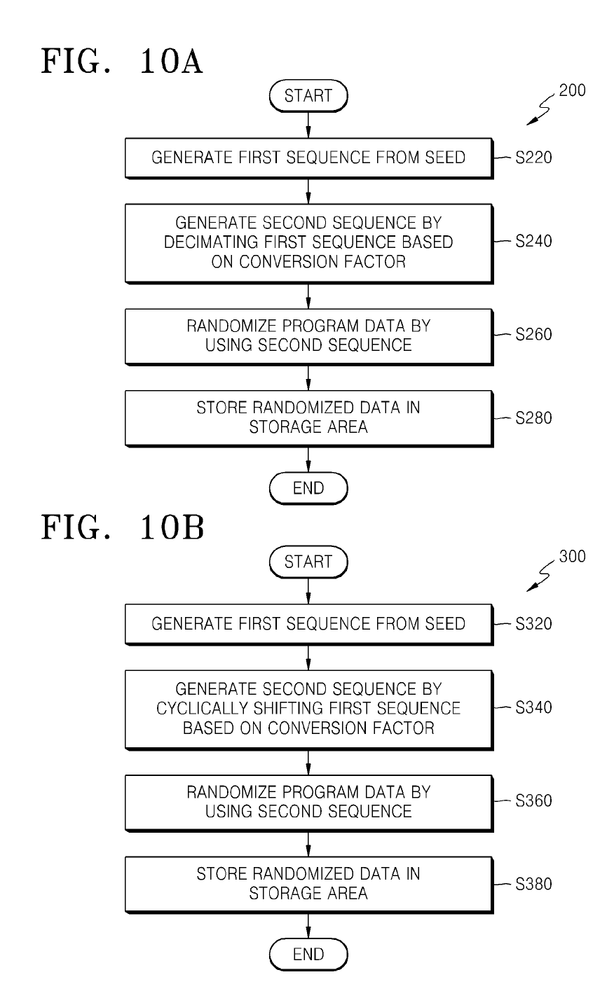

FIGS. 10A and 10B illustrate embodiments 200 and 300 of the operation S140 (refer to FIG. 1B) of converting the first sequence SEQ1 into the second sequence SEQ2 in response to a conversion factor in the data program method 100 of the memory device MEM including the randomizer RAN of FIG. 1A. FIG. 10A may include an operation S240 of generating the second sequence SEQ2 by decimating the first sequence SEQ1 based on the conversion factor Tf. FIG. 10B may include an operation S340 of generating the second sequence SEQ2 by cyclically shifting the first sequence SEQ1 based on the conversion factor Tf. Descriptions of the remaining operations illustrated in FIGS. 10A and 10B are similar to FIGS. 5A through 8C.

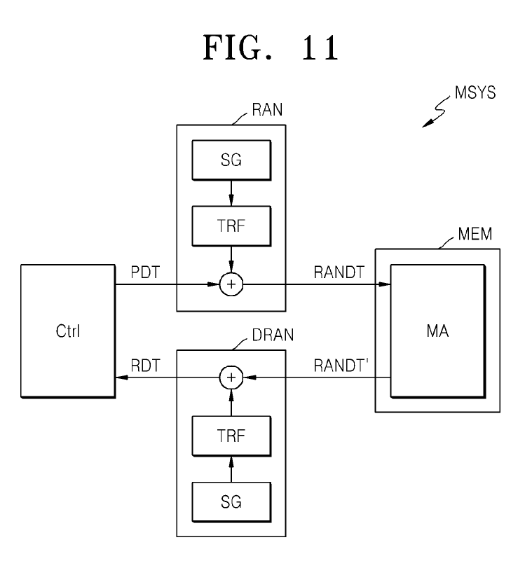

FIG. 11 is a block diagram of a memory system MSYS including a randomizer RAN according to an embodiment. In the memory system MSYS, a memory controller Ctrl may control a data programming and a data reading. In other words, the memory controller Ctrl may provide a randomizer RAN with program data PDT applied through a user interface (not shown). In addition, the memory controller Ctrl may receive read data RDT from the randomizer RAN and provide the read data RDT to the user interface.

The randomizer RAN of the memory system MSYS may receive data from the memory controller Ctrl. The randomzer RAN may generate a first sequence SEQ1 from a seed SEED. In addition, the randomizer RAN may convert the first sequence SEQ1 into a second sequence SEQ2 based on a conversion factor Tf. In addition, the randomizer RAN may perform an exclusive OR operation on the second sequence SEQ2 and the program data PDT, generate a random data RANDT, and may output the random data RANDT. The random data RANDT output from the randomizer RAN may be provided to a memory device MEM and be stored in a storage area (not shown) of the memory device MEM. The randomizer RAN of the memory system MSYS may be the same as that of the memory device MEM illustrated in FIG. 1A. Accordingly, the randomizer RAN may include a sequence generator SG and a converter TRF. A processing unit (not shown) of the converter TRF may convert the first sequence SEQ1 into the second sequence SEQ2 by decimation or cyclic shift. Because an operation and configuration of the randomizer RAN of the memory system MSYS are similar to those of the randomizer RAN of the memory device MEM illustrated in FIG. 1A, explanations of the operation and configuration of the randomizer RAN of the memory system MSYS are not provided. In addition, the memory system MSYS may include the memory device MEM receiving the random data RANDT and storing the random data RANDT in the storage area.

The memory system MSYS may include a de-randomizer DRAN de-randomizing the random data RANDT′ stored in the storage area of the memory device MEM. The de-randomizer DRAN may have the same structure as that of the randomizer RAN. However, the de-randomizer DRAN receives the random data RANDT′ stored in the storage area of the memory device MEM, performs an exclusive OR operation on the random data RANDT′ and a converted sequence, and then outputs restored read data RDT.

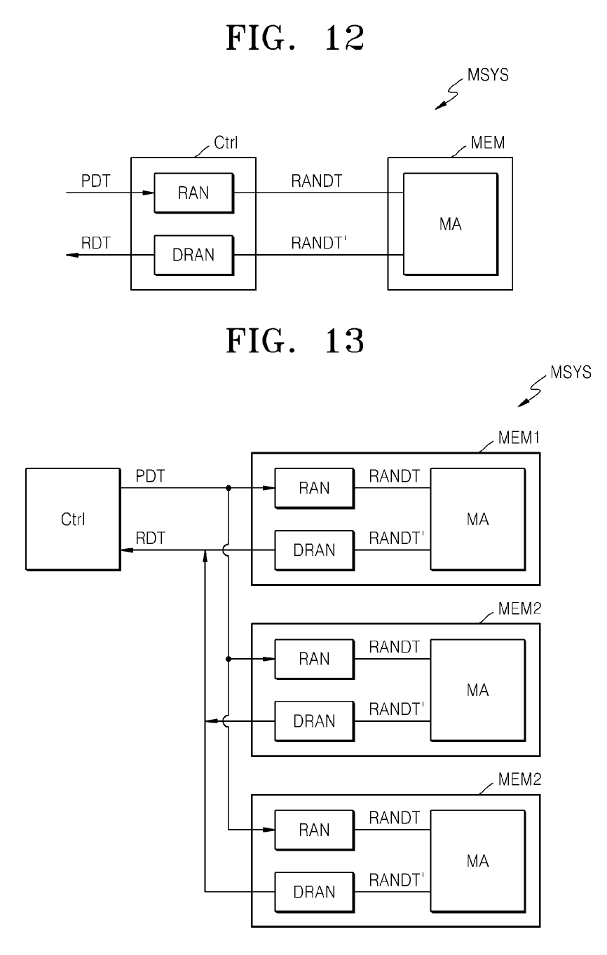

FIG. 12 is a block diagram illustrating a memory system according to another embodiment. Referring to FIG. 12, a randomizer RAN may be disposed in a memory controller Ctrl. However, embodiments are not limited The randomizer RAN, may be disposed in the memory device MEM (refer to FIG. 1).

FIG. 13 is a block diagram a memory system MSYS including a plurality of memory devices MEM1, MEM2, and MEM3, according to another embodiment. Referring to FIG. 13, the memory system MSYS includes a memory controller Ctrl and the memory devices MEM1, MEM2, and MEM3. In FIG. 13, each of the memory devices MEM1, MEM2, and MEM3 includes a randomizer RAN and a de-randomizer DRAN. However, embodiments are not limited. As in the memory system MSYS of FIGS. 11 and 12, the randomizer RAN and the de-randomizer DRAN may be disposed in various forms.

FIG. 14 is a block diagram, according to an embodiment, illustrating a computing system CSYS including the memory system MSYS of FIG. 11. The computing system CSYS includes a processor CPU, a user interface UI, and the memory system MSYS, which are electrically connected to each other via a bus BUS. The memory system MSYS includes a memory controller Ctrl and a memory device MEM. N-bit data (here, N is an integer which is 1 or more) processed or to be processed by the processor CPU is stored in the memory device MEM through the memory controller Ctrl. The memory system MSYS of FIG. 14 may be the same as the memory system MSYS of FIG. 11. Accordingly, the reliability of the computing system CSYS may be improved because a malfunction of the memory system MSYS is prevented.

The computing system CSYS may further include a power supply device PS. In addition, in the case where the memory device MEM is a flash memory device, the computing system CSYS may further include a volatile memory device, i.e., a random access memory (RAM). In the case where the computing system CSYS is a mobile device, the computing system CSYS may further include a battery (not shown) for supplying an operating voltage to the computing system CSYS and a modem (not shown) such as a baseband chipset. In addition, although not shown, the computing system CSYS may further include an application chipset, a camera image processor (CIS), a mobile dynamic random access memory (DRAM), etc.

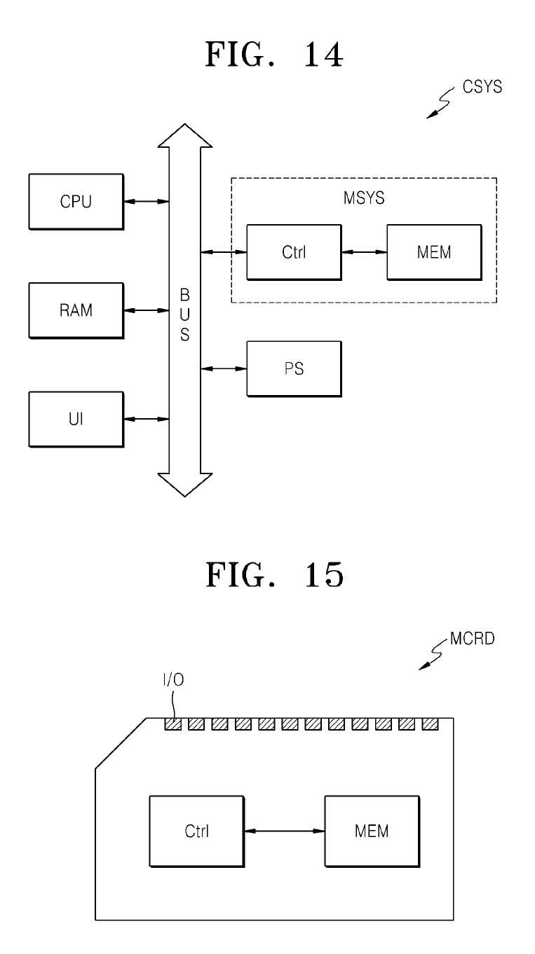

FIG. 15 is a diagram illustrating a memory card MCRD according to an embodiment.

Referring to FIG. 15, the memory card MCRD includes a memory controller Ctrl and a memory device MEM. The memory controller Ctrl controls a data writing to the memory device MEM or a data reading from the memory device MEM in response to a request received through an input and output unit I/O (not shown) from an external host (not shown). In addition, in the case where the memory device MEM of FIG. 15 is a flash memory device, the memory controller CTRL controls an erasing operation of the memory device MEM. The memory controller CTRL of the memory card MCRD according to the present embodiment of the inventive concept may include interface units (not shown) for interfacing with a host device (not shown) and the memory device MEM, respectively, and a RAM (not shown) to perform the control operation. In particular, the memory controller CTRL of the memory card MCRD according to an embodiment may be the memory controller Ctrl of FIGS. 11-12. In addition, the memory device MEM of the memory card MCRD according to an embodiment may be the memory device MEM of FIG. 1. Accordingly, the reliability of the memory card MCRD may be improved because a malfunction is prevented during a data writing and reading.

The memory card MCRD of FIG. 15 may be embodied in a compact flash card (CFC), a microdrive, a smart media card (SMC), a multimedia card (MMC), a security digital card (SDC), a memory stick, and a universal serial bus (USB) flash memory driver.

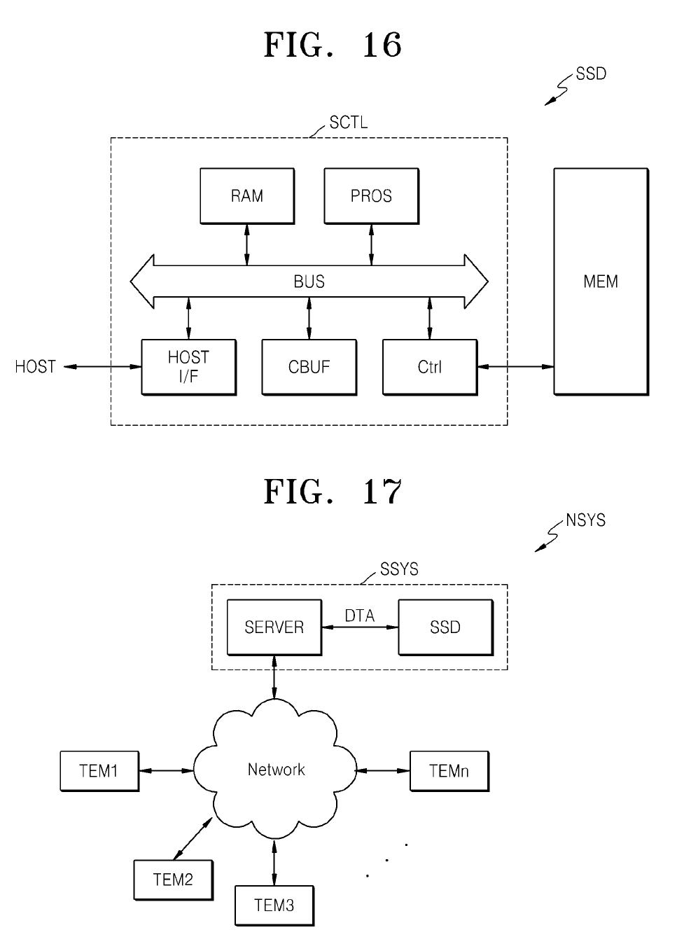

FIG. 16 is a block diagram illustrating a solid state drive (SSD) according to an embodiment.

Referring to FIG. 16, the SSD includes a solid state drive controller SCTL and a memory device MEM. The solid state drive controller SCTL may include a processor PROS, a RAM, a cache buffer CBUF, and a memory controller CTRL, which are connected to each other via a bus BUS. The processor PROS controls so that the memory controller CTRL transmits and receives data together with the memory device MEM in response to a request (commands, addresses, and data) of an external host (not shown). The processor PROS and the memory controller CTRL of the SSD according to an embodiment may be embodied in a single advanced reduced instruction set computer machine (ARM) processor. Data required for an operation of the processor PROS may be loaded to the RAM.

A host interface HOST I/F receives the request of the host and then transmits the request to the processor PROS, or transmits data received from the memory device MEM to the host. The host interface HOST I/F may interface with the host by using various interface protocols, i.e., universal serial bus (USB), man machine communication (MMC), peripheral component interconnect-express (PCI-E), serial advanced technology attachment (SATA), parallel advanced technology attachment (PATA), small computer system interface (SCSI), enhanced small device interface (ESDI), intelligent drive electronics (IDE), etc. Data to be transmitted to the memory device MEM or data transmitted from the memory device MEM may be temporarily stored in the cache buffer CBUF. The cache buffer CBUF may be a static random access memory (SRAM), etc. The memory controller CTRL and the memory device MEM included in the SSD according to the present embodiment may be the memory controller Ctrl and the memory device MEM of FIG. 11. respectively.

FIG. 17 is a diagram illustrating a server system SSYS including a solid state drive SSD and a network system NSYS including the server system SSYS.

Referring to FIG. 17, the network system NSYS may include the server system SSYS and a plurality of terminals TEM1 through TEMn, which are connected to each other through a network. The server system SSYS may include a server SERVER processing requests received from the plurality of terminals TEM1 through TEMn and the SSD storing data corresponding to the requests received from the plurality of terminals TEM1 through TEMn. The SSD of FIG. 17 may be the SSD of FIG. 16. In other words, the SSD of FIG. 17 may include the memory controller Ctrl and the memory device MEM illustrated in FIG. 11. Accordingly, the network system NSYS may improve an error correction capability even though having the same data compression rate because the network system NSYS includes the server system SSYS providing a large storage area and a high reliability

An aforementioned semiconductor memory device and a memory system including the same according to an embodiment may be packaged using various types of packages. For example, the semiconductor memory device may be packaged using a package on package (POP), a ball grid array (BGA), a chip scale package (CSP), a plastic leaded chip carrier (PLCC), a plastic dual in-line package (PDIP), a die in waffle pack (DWP), a die in wafer form (DWF), a chip on board (COB), a ceramic dual in-line package (CERDIP), a plastic metric quad flat pack (MQFP), a thin quad flat pack (TQFP), a small outline (SOIC), a shrink small outline package (SSOP), a thin small outline (TSOP), a thin quad flat pack (TQFP), a system in package (SIP), a multi-chip package (MCP), a wafer-level fabricated package (WFP), a wafer-level processed stack package (WSP), etc.

Embodiments have been particularly shown and described with reference to exemplary embodiments thereof. Here, although the specific terms have been used to describe the embodiments, these terms are for the purpose of describing the embodiments only and are not intended to limit the meaning of the exemplary embodiments or the scope of the exemplary embodiments as defined by the following claims. Therefore, it will be understood by those of ordinary skill in the art that various changes in form and details may be made therein without departing from the spirit and scope of the embodiments as defined by the following claims.

What is claimed is:

1. A memory device comprising:
a randomizer comprising a sequence generator which generates a first sequence from a seed and a converter which converts the first sequence into a second sequence in response to a conversion factor, the randomizer randomizing data to be programmed using the second sequence and outputting the randomized data; and
a storage area which receives the randomized data from the randomizer and stores the randomized data.

2. The memory device of claim 1, wherein the converter comprises:
a control unit which generates the conversion factor; and
a processing unit which converts the first sequence into the second sequence in response to the conversion factor.

3. The memory device of claim 2, wherein the processing unit comprises a decimator which extracts bits of the first sequence at an interval of the conversion factor and generates the second sequence.

4. The memory device of claim 2, wherein the processing unit comprises a cyclic shifter which cyclically shifts the first sequence and converts the cyclically-shifted first sequence into the second sequence.

5. The memory device of claim 2, wherein the processing unit comprises:
a decimator which extracts bits of the first sequence at an interval of the conversion factor and generates a temporary sequence; and
a shifter which shifts the temporary sequence and generates the second sequence.

6. The memory device of claim 2, wherein the processing unit comprises:
a cyclic shifter which cyclically shifts the first sequence and generates a temporary sequence; and
a decimator which extracts bits of the temporary sequence at an interval of the conversion factor and generates the second sequence.

7. The memory device of claim 2, wherein the converter further comprises a buffer which stores the first sequence and provides a stored first sequence to the processing unit, so that the processing unit converts the stored first sequence into the second sequence in response to a plurality of conversion factors.

8. The memory device of claim 2, wherein the converter comprises a plurality of processing units, and the control unit provides the conversion factor to each of the plurality of processing units.

9. The memory device of claim 2, wherein the control unit generates the conversion factor by using a memory parameter, the conversion factor being coprime to a period of the first sequence and being smaller than the period of the first sequence and larger than or equal to “1”.

10. The memory device of claim 2, wherein the control unit generates the conversion factor having a size which is below a period of the first sequence, and provides the conversion factor to the processing unit as a primitive value per each of memory parameters of data to be programmed or a relative value in which the primitive value per each of the memory parameters are arithmetically operated.

11. The memory device of claim 1, wherein the randomizer further comprises a seed table which sets the seed and provides the seed to the sequence generator.

12. The memory device of claim 1, wherein the randomizer randomizes the data to be programmed by performing an exclusive OR operation on the second sequence and the data to be programmed.

13. A memory system comprising:
a memory controller which controls a data programming and a data reading and outputs data to be programmed;
a randomizer which receives the data to be programmed from the memory controller, generates a first sequence from a seed, converts the first sequence into a second sequence in response to a conversion factor, generates randomized data by performing an exclusive OR operation on the data to be programmed and the second sequence, and outputs the randomized data; and
a memory device which receives the randomized data from the randomizer and stores the randomized data in a storage area of the memory device.

14. The memory device of claim 13, wherein the randomizer is located in the memory controller or the memory device.

15. The memory device of claim 13, further comprising a de-randomizer which receives the stored randomized data in the storage area of the memory device, de-randomizes the randomized data, and outputs a derandomized data to the memory controller.

16. A method of data programming in a memory device, the method comprising:
generating a first sequence from a seed;
converting the first sequence into a second sequence in response to a conversion factor;
randomizing data to be programmed using the second sequence; and
storing the randomized data.

17. The method of claim 16, wherein the converting the first sequence into the second sequence in response to the conversion factor further comprises:
decimating the first sequence at an interval of the conversion factor; and
generating the second sequence.

18. The method of claim 16, wherein the converting the first sequence into the second sequence in response to the conversion factor further comprises:
cyclically shifting the first sequence; and
converting the cyclically-shifted first sequence into the second sequence.
